(19) United States
(12) Patent Application Publication
(10) Pub. No.: US 2004/0239001 A1
(43) Pub. Date: Dec. 2, 2004

(54) Method of forming a respiratory conduit

(76) Inventors: Deshitha Airawana Edirisuriya, Auckland (NZ); David Peter Baldwin, Christhchurch 4 (NZ); Kristopher Poh Ming Laurent, Auckland (NZ)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/820,543

(22) Filed: Apr. 8, 2004

Related U.S. Application Data
(63) Continuation-in-part of application No. 10/314,812, filed on Dec. 9, 2002.

(30) Foreign Application Priority Data
Dec. 14, 2001 (NZ) 516153

(51) Int. Cl. B29C 45/14

(52) U.S. Cl. 264/255; 264/279

(57) ABSTRACT

The present invention relates to delivery conduits used in systems that provide positive pressure ventilation therapy. In particular, the present invention relates to a sleeve that allows flexible conduits to be joined and sealed to a thermoplastic connector, allowing for gases to be supplied to the conduit. The sleeve is used in the over moulding of an end connector onto the conduit. The sleeve and method of attaching a connector to a conduit of the present invention has the advantage that it prevents the connector from loosening or breaking when the conduit is bent, pulled or stressed, which can occur in some cases where the connector is attached to the conduit using a bond, such as glue. Furthermore, the occurrences of flashing of plastic across the conduit walls will be prevented during moulding, ensuring that no air or water leakages occur within the conduit walls. In a further embodiment a rubber cuff may be used with the conduit in order to mould a connector about the end of a conduit.

### BACKGROUND OF THE INVENTION

1. Field of the Invention

The present invention relates to delivery conduits used in systems that provide positive pressure ventilation therapy. In particular, the present invention relates to a method of forming a connector on a conduit and a sleeve used in the method that allows flexible conduits to be joined and sealed to a thermoplastic connector, allowing for gases to be supplied to the conduit.

2. Summary of the Prior Art

Administration of positive pressure ventilation is a common method of treating Obstructive Sleep Apnoea syndrome and Upper Airway Resistance syndrome. Some forms of delivery systems that can be used for ventilation therapy are; CPAP (Continuous Positive Airway Pressure), VPAP (Variable Positive Airway Pressure) and BiPAP (Bi-level Positive Airway Pressure).

The delivery of gases to the patient requires, in the very least, a nose, mouth, or face mask fitted to the patient with a connection via a flexible gases delivery conduit to a gases flow generator. One requirement of the delivery conduit is to provide humidified air at a particular pressure to the patient, via the mask. The conduit therefore requires connectors at each end that provide effective sealing and connection of the conduit to the mask, humidifier and/or air flow generator of the positive pressure ventilation system, so that there is no or low pressure loss along the delivery conduit.

There are a variety of methods for fitting a connector to a flexible helically wound conduit, such as the tubing disclosed in U.S. Pat. No. 5,848,223. This patent discloses a conduit that is a tube having a helically wound support bead between inner and outer walls. A helically wrapped electrical resistance beating conduit is disposed adjacent to the inner wall, in good heat transfer relation to fluid and/or air that flows within the tube. The majority of these connections are made by threading the connector onto the conduit and then gluing the connector to the conduit. For example, U.S. Pat. No. 3,963,856 discloses a connection or fitting that is bonded to a conduit or tubing. The fitting has an internal thread that is simply threaded onto the external bead or wall of the tubing. Here it is disclosed that the bond may be adhesive or of the heat seal type. A further other commonly used method is to mould the connector directly onto the conduit.

The abovementioned methods are operator intensive and/or may result in the conduit being damaged. Usage and bending of the flexible conduit may cause loss of adherence from the glue and it may also cause breakages where the conduit is stressed during the moulding process.

A further method used is the over moulding of the connector onto a clip and conduit, where the clip is attached to one end of the conduit. Here the clip is partially annular in shape and is placed over and in between a cut made in the outer wall of the conduit, therefore the clip sits in between the bead. A connector is then moulded around the clip and conduit. With this method the conduit is often compressed, and with high temperatures and pressures used during moulding excess plastic flashing can be forced from the mould across the connector to the outer wall of the tubing.

Plastic flashings and hot plastic may during moulding touch the outer wall of the conduit at the connector interface causing damage to the tubing walls, leading to water and air seepage into and out of the conduit.

### SUMMARY OF THE INVENTION

It is an object of the present invention to provide a method of forming a ventilation conduit that goes some way to overcoming the abovementioned disadvantages in the prior art or which will at least provide the industry with a useful choice.

Accordingly in a first aspect the present invention consists in a method of forming a connector on the end of a flexible conduit comprising the steps of:

a) forming a sleeve of the type comprising:

a section of hollow cylinder having a thread on its interior surface, said thread being of corresponding size and shape to the outer surface of said conduit,

b) threading said sleeve onto one of the ends of said conduit,

c) moulding said connector over said conduit and said sleeve, causing said sleeve to become an integral part of the inner surface of said connector.

In a second aspect the present invention consists in a method of forming a connector on the end of a flexible conduit comprising the steps of:

a) over moulding a soft, flexible rubber cuff onto said conduit proximal to the end of said conduit, causing said cuff to blend with said conduit.

b) moulding said connector over said conduit and said cuff, causing said cuff to become an integral part of the inner surface of said connector.

In a third aspect the present invention may broadly be said to consist in a conduit having a connector, formed on at least one end of said conduit, in accordance with the method above.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

Preferred forms of the present invention will now be described with reference to the accompanying drawings.

FIG. 1 is a schematic view of ventilation apparatus that may utilise the conduit formed from a first method of the present invention.

FIG. 2 is an isometric view of the sleeve used in the first method of forming a conduit of the present invention.

FIG. 3 is a side view of the sleeve, in particular, showing hidden detail of the thread located on the inner surface of the sleeve.

FIG. 4 is a side view of the sleeve when located about the end of a conduit.

FIG. 5 is a cross sectional view of FIG. 4 taken across lines X-X.

FIG. 6 is a partial cross sectional view of the conduit and connector, once a connector has been moulded about the sleeve and conduit.

FIG. 6a is a partial cross sectional view of the end of a conduit and connector formed as described in a second method, showing the conduit, and a rubber cuff and over moulded conduit that form the connector.

FIG. 7 is a side view of the rubber cuff used in the second method of forming a conduit, over moulded in position about the end of the conduit.

FIG. 8 is a side view of the completed conduit formed as described in the second method, with the connector moulded onto the conduit and the rubber cuff.

### DETAILED DESCRIPTION OF THE PREFERRED EMBODIMENTS

The preferred embodiment of the sleeve of the present invention is used in the over moulding of an end connector onto a delivery conduit that may be used in medical apparatus or ventilation therapy systems. The connector allows for the delivery conduit to be connected to other apparatus in the ventilation system, such as, an air generator, humidifier or mask. In particular, the delivery conduit must be capable of providing air, usually humidified, to the patient at a particular pressure, in order for ventilation therapy to be successful.

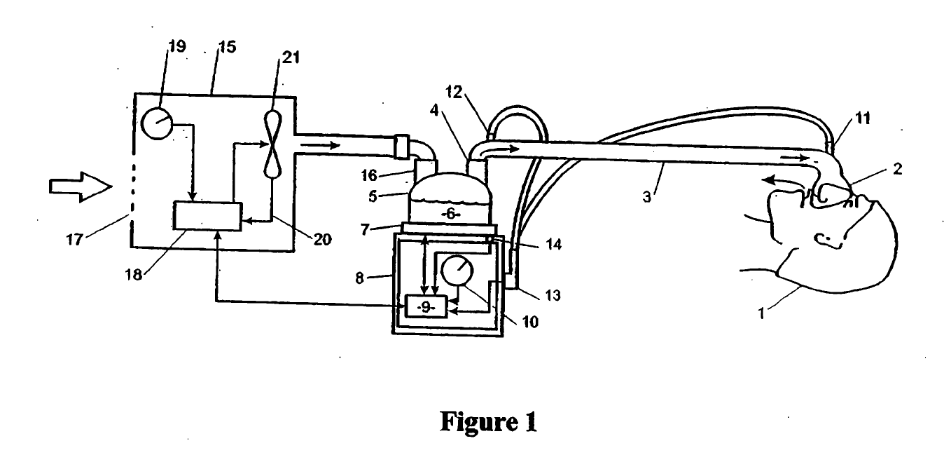

A typical patient ventilation therapy system that uses such a flexible delivery conduit of the type associated with the present invention is shown in FIG. 1. Here, a humidified positive pressure ventilation system is shown in which a patient 1 is receiving humidified and pressurised gases through a patient interface 2 connected to a humidified gases transportation pathway or delivery conduit 3. Delivery conduit 3 is connected to the outlet 4 of a humidification chamber 5, which contains a volume of water 6. Delivery conduit 3 usually contains heating means or heater wires (not shown), which heat the walls of the conduit to reduce condensation of humidified gases within the conduit. Humidification chamber 6 is preferably formed from a plastics material and may have a highly heat conductive base (for example an aluminium base) which is in direct contact with a heater plate 7 of humidifier 8. Humidifier 8 is provided with control means or electronic controller 9 which may comprise a microprocessor based controller executing computer software commands stored in associated memory.

Controller 9 receives input from sources such as user input means or dial 10 through which a user of the device may, for example, set a predetermined required value (preset value) of humidity or temperature of the gases supplied to patient 1. The controller may also receive input from other sources, for example temperature and/or flow velocity sensors 11 and 12 through connector 13 and heater plate temperature sensor 14. In response to the user set humidity or temperature value input via dial 10 and the other inputs, controller 9 determines when (or to what level) to energise heater plate 7 to heat the water 6 within humidification chamber 5. As the volume of water 6 within humidification chamber 5 is heated, water vapour begins to fill the volume of tie chamber above the water's surface and is passed out of the humidification chamber 5 outlet 4 with the flow of gases (for example air) provided from a gases supply means or blower 15 which enters the chamber through inlet 16. Exhaled gases from the patient's mouth are passed directly to ambient surroundings.

Blower 15 is provided with variable pressure regulating means or variable speed fan 21, which draws air or other gases through blower inlet 17. The speed of variable speed fan 21 is controlled by electronic controller 18 (or alternatively the function of controller 18 could be carried out by controller 9) in response to inputs from controller 9 and a user set predetermined required value (preset value) of pressure or fan speed via dial 19.

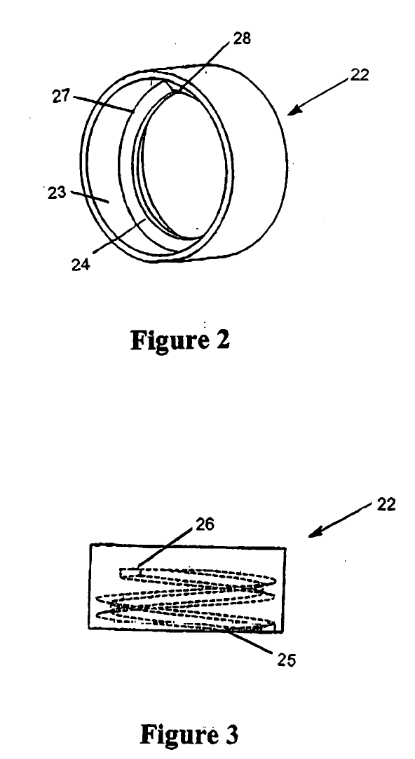

Referring now to FIGS. 2 and 3, a sleeve 22 having an internal surface 23 that is adapted for receiving a flexible conduit (indicated as 3 in FIG. 1) is shown. The conduit is preferably a double-walled helically wound flexible conduit or tube as disclosed in U.S. Pat. No. 5,848,223, but may be of other appropriate conduit construction. The internal surface 23 of the sleeve 22 has a thread 24 formed in it when moulded. The thread 24 is a complimentary size and shape to that of the outer surface of the conduit 3.

The sleeve 22 is preferably moulded from a thermoplastic material similar to the material the connector is manufactured or moulded from, but it is appreciated that other similar plastics materials may be used to construct the sleeve. The sleeve thread 24 is a helical thread having two different pitches 27 and 28. The thread 24 is shown in FIG. 2 as hidden detail. The start 25 of the thread 24 begins at the bottom of the sleeve 22 and ends 26 approximately two thirds up the height of the sleeve. The thread 24 consists of one and three-quarter rotations and has an inclining pitch 27 for one and a half rotations. The last quarter rotation 28 of the thread has no incline or decline. The ends of the thread 24 are also formed so as to taper into the inner surface of the sleeve 22; this makes it easier for a user to thread the sleeve onto the conduit.

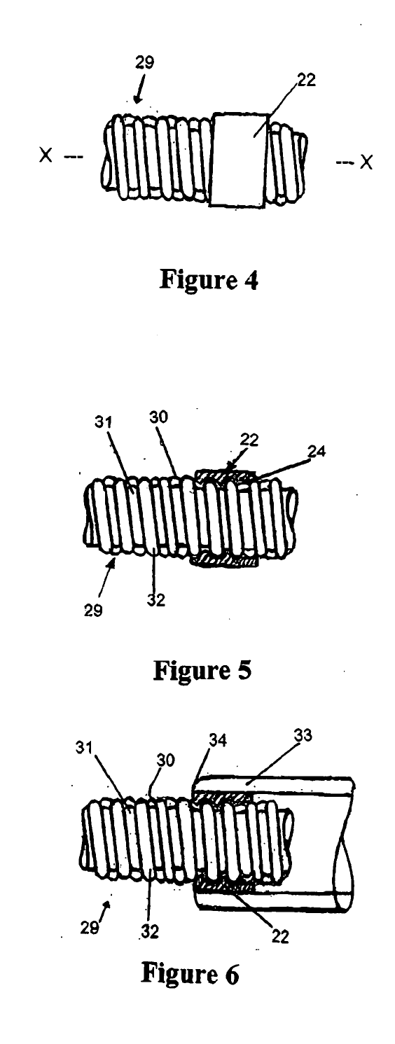

Reference is now made to FIGS. 4 and 5, which illustrate the sleeve 22 in use and located about a flexible conduit 29. The conduit 29 in this embodiment has an outer wall 30 and an inner wall 31 with electrical conductors (not shown) being disposed around the inner wall 31 with a support bead 32 surrounding the conductors and maintaining adhesion of the conductors to the inner wall. The support bead 32 has been heat bonded to the outside of the inner wall 31, this inner wall 31 being a thin-walled tubular body. The outer wall 30 is a ribbon applied over the wraps of the support bead spanning from one wrap to the next so as to define an outer wall for the conduit. The outer surface of the thread 24 abuts the outer wall 30 and, in the preferred form, causes a slight compression of the outer wall. As the thread 24 is slightly smaller in dimension than that of the outer wall 30 of the conduit 29, this causes there to be a tight fitting of the sleeve 22 about the conduit 29.

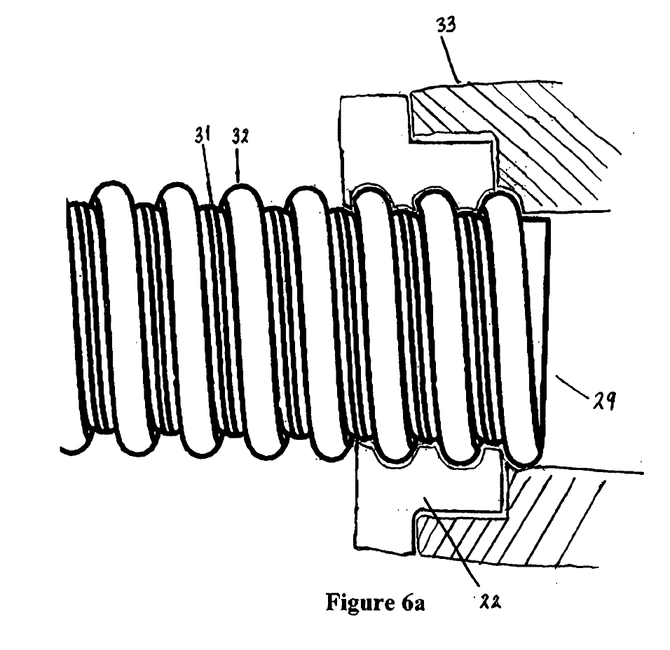

To obtain a conduit with a connector at one end, so that the conduit may be connected to other apparatus, such as a humidifier or blower, and to allow for gases to access and flow through said conduit, the sleeve 22 is threaded onto one end of the conduit 29. A connector is then moulded over the conduit and sleeve as shown in FIG. 6. During the over moulding process molten thermoplastic material is injected over the sleeve 22 and the conduit 29, resulting in a seal being made between the sleeve 22 and conduit 29, and a connector 33 is formed over the end of the conduit 29. As can be seen in FIG. 6, the sleeve 22 melts at least partially, and becomes part of the inner surface of the connector 33 as it blends with the connector 33 during moulding. The sleeve 22 protects the conduit 29 during this over moulding operation, shielding it from damage by the molten plastic that forms the connector 33. By the time the molten plastic flows around the ends of sleeve 22 and comes into contact with the conduit 29, it has cooled enough that any damage to the outer surfaces of the conduit 29 is insignificant. Furthermore, the sleeve 22 acts as a means to determine where to locate the connector 33 on the end of the conduit 29.

Although not shown in the Figures, in other forms of the method of conduit forming of the present invention the sleeve 22 may not be filly enclosed within the connector 33, but may extend slightly out of the end 34 of the connector 33 after the over moulding operation is completed. In this form the sleeve 22 provides enhanced effect in reducing the occurrence of plastic flashings across the conduit walls.

The moulding of the connector 33 over the sleeve 22 and conduit 29 results in the moulding together of the conduit 29 and the connector 33, preventing the causing of holes and thus leakages in the conduit. The sleeve 22 acts to protect the outer film layer 30 of the conduit 29 from being melted during over moulding process. The sleeve also acts as an insulator and prevents hot molten plastic from contact the conduit during over moulding process and preventing damage to the inner parts of the conduit.

During the moulding process the sleeve 22 in wound onto the conduit 29 and then the connector is moulded over the sleeve 22. The sleeve 22 protects the conduit 29 from the hottest temperature molten plastic, which melts the outer part of the sleeve 22 and blends with it, the heat from the molten plastic also causes the sleeve 22 to bond to the outer wall 30 of the conduit and hence the bonding of the outer wall 30 with the inner wall of the conduit 29.

The sleeve and method of attaching a connector to a conduit of the present invention has the advantage that it prevents the connector from loosening or breaking when the conduit is bent pulled or stressed which can occur in some cases where the connector is attached to the conduit using a bond such as glue. Furthermore, the occurrences of flashing of plastic across the conduit walls will be prevented during moulding, ensuring that the walls are not punctured and no air or water leakages occur within the conduit walls.

Finally, the pitch of the thread on the sleeve is less than that provided by the outer wall and bead on the conduit, providing ease of assembly.

It should be noted that though the embodiment described above is predominantly used for double-walled conduits the method described will work equally well for single walled conduits.

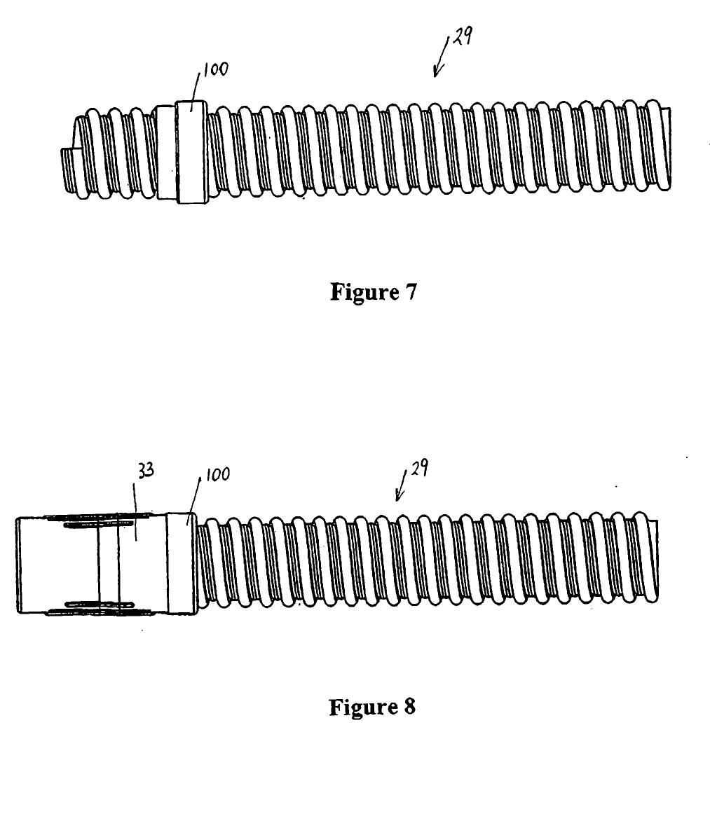

An alternative method of forming a conduit will now be described with reference to FIGS. 6a, 7 and 8. The sleeve of the above described method is replaced in this alternative method by a soft rubber cuff 100, which is over moulded into place on the conduit 29. In this form the conduit is illustrated and described as a single wall conduit, but the rubber cuff 100 may be used with a double wall conduit similar to that described above. The cuff 100 is made of a rubbery compound with a low melting point, so that the over moulding process will not adversely affect the integrity of conduit 29. In the over moulding process, the wall 31 and bead 32 enclosed by the rubber cuff 100 blend with the cuff 100 and each other, forming a seal between the cuff 100 and the conduit 29. A connector 33 is then moulded over the cuff 100, in such a way that the end of the cuff 100 furthest from the patient 1 is not fully enclosed. The connector 33 blends with the cuff 100 to form a seal. The cuff 100 prevents hot molten plastic from the connector 33 from coming into contact with the enclosed part of the conduit 29, shielding it from damage. Any damage occurring to the unshielded part of the conduit 29, between the cuff 100 and the patient 1 end of the conduit 29 is unimportant, due to the seal formed between cuff 100 and connector 33, and the seal between the cuff 100 and the conduit 29.

This method of attaching a connector to a conduit of the present invention has the advantage that the cuff 100 provides stress relief, cushioning the conduit 29 from any bending, pulling or other stresses from the connector 33. Furthermore, as the connector 33 is moulded onto the cuff 100, and not directly onto the conduit, there is no plastic flashing across the wall 31 of the conduit 33 where the conduit 33 is exposed, ensuring that no air or water leakages occur between the conduit walls.

We claim:

1. A method of fonning a connector on the end of a flexible conduit comprising the steps of:
a) forming a sleeve of the type comprising a section of hollow cylinder having a thread on its interior surface, said thread being of corresponding size and shape to the outer surface of said conduit,
b) threading said sleeve onto one of the ends of said conduit,
c) moulding said connector over said conduit and said sleeve, causing said sleeve to become an integral part of the inner surface of said connector.

2. A method of forming a connector on the end of a flexible conduit according to claim 1 wherein said conduit is a helically wound tube having an outer wall and inner wall, and including at least one electrical conductor wrapped around said inner wall which is covered with a bead.

3. A method of forming a connector on the end of a flexible conduit according to claim 1 wherein said connector is moulded over said conduit and said sleeve, and the edge of said sleeve is not aligned with the edge of said connector, such that the finished connector has part of said sleeve extending there from.

4. A conduit having a connector, formed on at least one end of said conduit in accordance with claim 1.

5. A conduit having a connector according to claim 4 wherein at least a sleeve is embedded in said connector and about said conduit and at least part of said sleeve extends out to form said connector.

6. A method of forming a connector on the end of a flexible conduit comprising the steps of:
a) over moulding a soft, flexible rubber cuff onto said conduit proximal to the end of said conduit, causing said cuff to blend with said conduit.
b) moulding said connector over said conduit and said cuff, causing said cuff to become an integral part of the inner surface of said connector.

7. A method of forming a connector on the end of a flexible conduit according to claim 6 wherein said rubber cuff is formed of a material with a low melting point.

8. A method of forming a connector on the end of a flexible conduit according to claim 6 or claim 7 wherein said conduit is a helically wound tube and includes at least one electrical conductor wrapped around said conduit, said electrical conductor being covered with a bead.

9. A method of forming a connector on the end of a flexible conduit according to claim 6 or claim 7 wherein said conduit is a helically wound tube having an outer wall and an inner wall and includes at least one electrical conductor wrapped around said inner wall, said electrical conductor being covered with a bead.
